(19) United States
(12) Patent Application Publication
(10) Pub. No.: US 2025/0159759 A1
(43) Pub. Date: May 15, 2025

(54) ELECTRONIC DEVICE FOR PERFORMING MCPTT FUNCTION AND METHOD FOR OPERATING SAME

(71) Applicant: Samsung Electronics Co., Ltd., Suwon-si (KR)

(72) Inventors: Sangwook WOO, Suwon-si (KR); Chungho SHIN, Suwon-si (KR); Kyungmi JANG, Suwon-si (KR); Sujin HWANG, Suwon-si (KR)

(21) Appl. No.: 19/022,445

(22) Filed: Jan. 15, 2025

Related U.S. Application Data
(63) Continuation of application No. PCT/KR2023/010075, filed on Jul. 14, 2023.

(30) Foreign Application Priority Data
Aug. 22, 2022 (KR) 10-2022-0104536
Sep. 6, 2022 (KR) 10-2022-0112752

(51) Int. Cl. H04W 76/45; H04L 65/4061; H04W 4/10; H04W 24/10

(52) U.S. Cl. CPC H04W 76/45; H04L 65/4061; H04W 4/10; H04W 24/10

(57) ABSTRACT

An electronic device is provided. The electronic device includes a communication circuitry, memory storing one or more computer programs, and one or more processors operatively connected to the communication circuitry and the memory, wherein the one or more computer programs include computer-executable instructions that, when executed by the one or more processors indivudally or collectively, cause the electronic device to establish at least one multimedia broadcast and multicast service (MBMS) subchannel with a mission critical push to talk (MCPTT) server, and, while the at least one MBMS subchannel has been established, sends a message related to switching to a unicast method, to the MCPTT server, if the reception delay time of a control message related to the MBMS subchannel received through a general purpose MBMS subchannel (GPMS) satisfies a specified first switching condition.

### CROSS-REFERENCE TO RELATED APPLICATION(S)

This application is a continuation application, claiming priority under § 365 (c), of an International application No. PCT/KR2023/010075, filed on Jul. 14, 2023, which is based on and claims the benefit of a Korean patent application number 10-2022-0104536, filed on Aug. 22, 2022, in the Korean Intellectual Property Office, and of a Korean patent application number 10-2022-0112752, filed on Sep. 6, 2022, in the Korean Intellectual Property Office, the disclosure of each of which is incorporated by reference herein in its entirety.

### BACKGROUND

### 1. Field

The disclosure relates to an electronic device for performing a mission critical push to talk (MCPTT) function and a method of operating the same.

### 2. Description of Related Art

A MCPTT function is a communication technology that provides a push to talk (PTT) function based on a mobile communication such as a long-term evolution (LTE) communication technology. The MCPTT function may be used for public safety in an emergency situation such as disaster, traffic accident, and/or fire.

The above information is presented as background information only to assist with an understanding of the disclosure. No determination has been made, and no assertion is made, as to whether any of the above might be applicable as prior art with regard to the disclosure.

### SUMMARY

An MCPTT function may support communication of a unicast scheme and/or a multicast scheme between an MCPTT server and an electronic device. For example, the MCPTT server may transmit voices, images, text messages, files, and/or location information to the electronic device through the unicast scheme. For example, when the number of electronic devices located in a service area exceeds a reference number, the MCPTT server may limit provision of the PTT function to the electronic devices located in the service area through the unicast scheme. When the number of electronic devices located in the service area exceeds the reference number, the MCPTT server may switch a communication scheme with the MCPTT server to the multicast scheme. The electronic device may receive data from the MCPTT server within the service area related to the MCPTT server, based on the multicast scheme.

When it is determined that the electronic device escapes the service area related to the MCPTT server in the state where the communication scheme with the MCPTT server is configured as the multicast scheme, it is possible to switch the communication scheme with the MCPTT server to the unicast scheme by transmitting information (for example, a not-listening status report) related to the escape from the service area to the MCPTT server. The MCPTT server may transmit data through the multicast scheme before the information related to the escape from the service area is received from the electronic device. When the electronic device escapes the service area related to the MCPTT server, reception of data from the MCPTT server may be disconnected until a time point at which the communication scheme with the MCPTT server switches to the unicast scheme.

Aspects of the disclosure are to address at least the above-mentioned problems and/or disadvantages and to provide at least the advantages described below. Accordingly, an aspect of the disclosure is to provide an apparatus and a method for reducing disconnection of reception of data related to the MCPTT function by the electronic device.

Additional aspects will be set forth in part in the description which follows and, in part, will be apparent from the description, or may be learned by practice of the presented embodiments.

In accordance with an aspect of the disclosure, an electronic device is provided. The electronic device includes a communication circuit, memory storing one or more computer programs, and one or more processors operatively connected to the communication circuit and the memory, wherein the one or more computer programs include computer-executable instructions that, when executed by the one or more processors individually or collectively, cause the electronic device to establish a group call with a mission critical push to talk (MCPTT) server through the communication circuit, establish at least one multimedia broadcast and multicast service (MBMS) subchannel with the MCPTT server through the communication circuit, identify a reception delay time of a control message related to an MBMS subchannel received through a general purpose MBMS subchannel (GPMS) in a state where the at least one MBMS subchannel is established, and transmit a message related to switching to a unicast scheme to the MCPTT server through the communication circuit when the reception delay time of the control message related to the MBMS subchannel satisfies a predetermined first switching condition.

In accordance with another aspect of the disclosure, a method performed by an electronic device is provided. The method includes establishing a group call with the MCPTT server, establishing at least one MBMS subchannel with the MCPTT server, identifying a reception delay time of a control message related to an MBMS subchannel received through a GPMS in the state in which at least one MBMS subchannel is established, and transmitting a message related to switching to the unicast scheme to the MCPTT server when the reception delay time of the control message related to the MBMS subchannel satisfies a predetermined first switching condition.

In accordance with another aspect of the disclosure, one or more non-transitory computer-readable media storing one or more computer programs including computer-executable instructions that, when executed by one or more processors of an electronic device individually or collectively, cause the electronic device to perform operations is provided. The operations include establishing a group call with a mission critical push to talk (MCPTT) server, establishing at least one MBMS subchannel with the MCPTT server, identifying a reception delay time of a control message related to an MBMS subchannel received through a GPMS in a state where the at least one MBMS subchannel is established, and transmitting a message related to switching to a unicast scheme to the MCPTT server when the reception delay time of the control message related to the MBMS subchannel satisfies a predetermined first switching condition.

According to an embodiment of the disclosure, when it is predicted that the electronic device escapes a service area of an MCPTT server, based on a reception delay time of a control message (for example, a map group to bearer message) related to an MBMS subchannel in the state in which the multimedia broadcast multicast service (MBMS) subchannel is established with a mission critical push to talk (MCPTT) server, it is possible to switch a communication scheme with the MCPTT server to a unicast scheme without any disconnection of data reception from the MCPTT server by switching an MCPTT function to the unicast scheme through transmission of a message related to switching to the unicast scheme to the MCPTT server.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device within a network environment according to an embodiment of the disclosure;

FIG. 2 illustrates an example of a wireless communication system for an MCPTT function according to an embodiment of the disclosure;

FIG. 3 illustrates an example of a wireless communication system for an MCPTT function according to an embodiment of the disclosure;

FIG. 4 is a block diagram of the electronic device for the MCPTT function according to an embodiment of the disclosure;

FIG. 5 is a flowchart illustrating a process in which the electronic device provides the MCPTT function according to an embodiment of the disclosure;

FIG. 6 is a flowchart illustrating a process in which the electronic device switches to a unicast scheme, based on a reception delay time of a control message according to an embodiment of the disclosure;

FIG. 7 is a flowchart illustrating a process in which the electronic device switches a communication scheme with the MCPTT server to the unicast scheme according to an embodiment of the disclosure;

FIG. 8 is a flowchart illustrating a process in which the electronic device switches the communication scheme with the MCPTT server to a multicast scheme according to an embodiment of the disclosure;

FIG. 9 illustrates an example in which the electronic device provides the MCPTT function by according to an embodiment of the disclosure; and

FIG. 10 illustrates an example in which the electronic device provides the MCPTT function according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

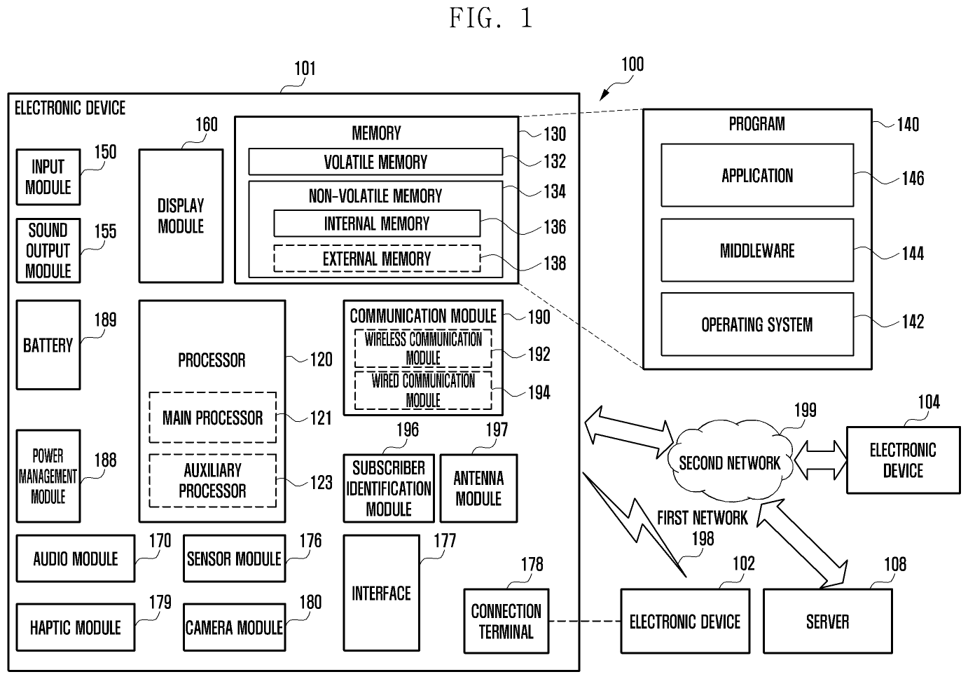

FIG. 1 is a block diagram illustrating an example electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connection terminal 178, a haptic module 179, a camera module 180, a power management module 188, a battery 189, a communication module 190, a subscriber identification module (SIM) 196, or an antenna module 197. In some embodiments, at least one of the components (e.g., the connection terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter-wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC. According to an embodiment, the subscriber identification module 196 may include a plurality of subscriber identification modules. For example, the plurality of subscriber identification modules may store different subscriber information.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band. For example, the plurality of antennas may include a patch array antenna and/or a dipole array antenna.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102 or 104, or server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

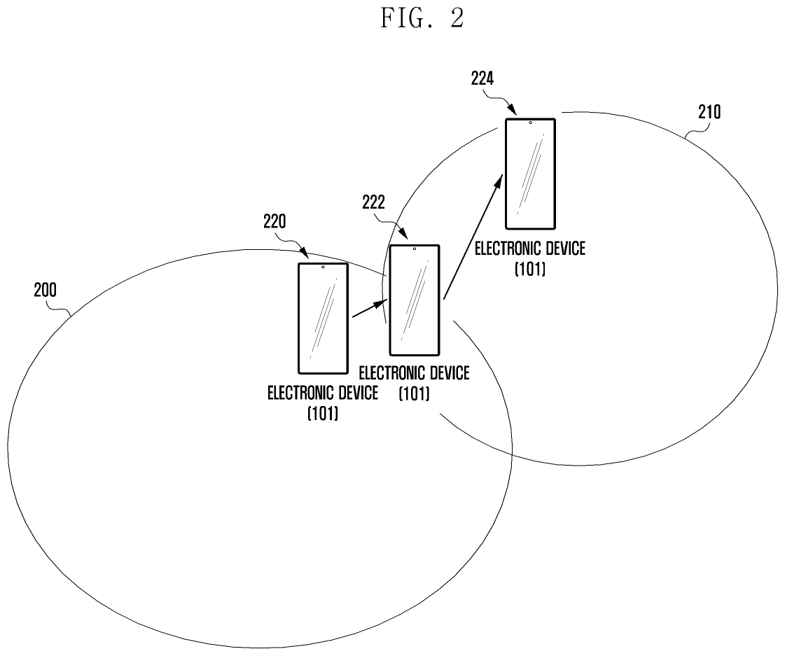

FIG. 2 illustrates an example of a wireless communication system for a MCPTT function according to an embodiment of the disclosure.

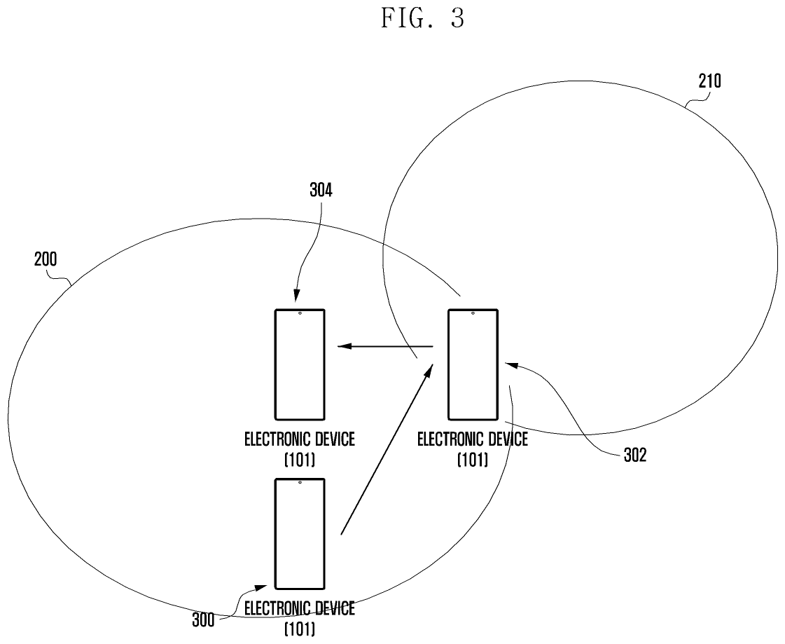

FIG. 3 illustrates an example of a wireless communication system for a MCPTT function according to an embodiment of the disclosure.

For example, the electronic device 101 of FIGS. 2 and 3 may be at least partially similar to the electronic device 101 of FIG. 1 or may include another embodiment of the electronic device.

Referring to FIGS. 2 and 3, the electronic device 101 may perform communication with a mission critical push to talk (MCPTT) server through a unicast scheme and/or a multicast scheme. According to an embodiment, when the electronic device 101 is located within a first service area 200 supporting a multimedia broadcast multicast service (MBMS) function (220 or 300), the MCPTT server may transmit data (for example, media packets) to the electronic device 101 through the unicast scheme or the multicast scheme. According to an embodiment, the electronic device 101 may transmit data to the MCPTT server within the first service area 200 through the unicast scheme. For example, the MCPTT server is a network entity that provides the MCPTT function to at least one electronic device (for example, the electronic device 101) and may communicate with at least one electronic device base station (BS) (for example, the electronic device 101) through at least one base station (for example, evolved node B(eNB)). For example, the MCPTT server may include a group communication service enabler application server (GCSE-AS). For example, the first service area 200 supporting the MBMS function is a service area supporting the unicast scheme and the multicast scheme for the MCPTT function and may include the coverage of at least one BS supporting the MBMS function.

According to various embodiments, the MCPTT server may provide the MCPTT function through the unicast scheme or the multicast scheme, based on the number of electronic devices belonging to a specific group located within the first service area 200. For example, the MCPTT server may identify the electronic devices 101 located within the first service area 200, based on location information (for example, a location report message) periodically received from the electronic device 101. For example, the MCPTT server may identify the electronic devices 101 (or the number of electronic devices 101) which are making a group call within the specific group, based on information related to the group call received from the electronic devices 101.

According to an embodiment, when the number of electronic devices belonging to the specific group within the first service area 200 is equal to or smaller than a predetermined reference number, the MCPTT server may determine that the unicast scheme is used for the electronic devices belonging to the specific group within the first service area 200. For example, the MCPTT server may transmit data (for example, media packets) to each of the electronic devices 101 located in the first service area 200 through the unicast scheme. The electronic devices 101 may transmit data to the MCPTT server through the unicast scheme.

According to an embodiment, when the number of electronic devices belonging to the specific group within the first service area 200 exceeds a predetermined reference number, the MCPTT server may determine that the multicast scheme is used for the electronic devices belonging to the specific group within the first service area 200. For example, the MCPTT server may transmit data (for example, media packets) to the electronic devices of the specific group located in the first service area 200 through the multicast scheme. Each of the electronic devices 101 may transmit data to the MCPTT server through the unicast scheme.

According to various embodiments, when data is received from the MCPTT server through the multicast scheme, the electronic device 101 may determine whether the multicast scheme can be continuously used. According to an embodiment, the electronic device 101 may determine whether the multicast scheme can be continuously used based on a reception delay time of a control message related to an MBMS subchannel which is periodically transmitted by the MCPTT server, based on a predetermined second period. For example, when the reception delay time of the control message related to the MBMS subchannel which exceeds a predetermined reference delay time is continuously detected by a first reference number, the electronic device 101 may determine that the electronic device 101 is located at the edge (or in the weak electric field) of the first service area 200 (222 or 302). When it is determined that the electronic device 101 is located at the edge of the first service area 200 (222 or 302), the probability that the electronic device 101 escapes the first service area 200 is relatively high, and thus it may be determined that the multicast scheme cannot be continuously used. For example, the reception delay time of the control message related to the MBMS subchannel may include difference between a time point of the control message related to the MBMS subchannel received at a previous time point (for example, a time point of n−1) is received and a time point at which the control message related to the MBMS subchannel received at the current time point (for example, a time point of n) is received. For example, the reception delay time of the control message related to the MBMS subchannel may include an elapsed time from a time point (for example, the predetermined second period) at which the control message related to the MBMS subchannel is received from the MCPTT server to a time point at which the control message related to the MBMS subchannel is received. For example, the predetermined first reference number may indicate a reference number for determining whether the multicast scheme is used based on reception of the control message related to the MBMS subchannel that exceeds the predetermined reference delay time.

According to an embodiment, the electronic device 101 may determine whether the multicast scheme can be continuously sued based on the number of receptions of the control message related to the MBMS subchannel for a predetermined first time. For example, when the number of receptions of the control message related to the MBMS subchannel for the predetermined first time is equal to or smaller than a predetermined second reference number, the electronic device 101 may determine that the multicast scheme cannot be continuously used. For example, the predetermined first time may include a reference time configured to identify the number of receptions of the control message related to the MBMS subchannel in order to determine whether the multicast scheme is used. For example, the predetermined second reference number is a reference number for determining whether the multicast scheme is used based on the number of receptions of the control message related to the MBMS subchannel and may be configured as a value which is the same as or different from the predetermined first reference number.

According to an embodiment, when timeout related to a floor request is generated, the electronic device 101 may determine that the multicast scheme cannot be continuously used. For example, the timeout related to the floor request may be generated when the electronic device 101 does not acquire the floor for a second time from a time point at which a floor request message is transmitted to secure the floor. For example, the predetermined second time is a predetermined reference time to determine whether the timeout related to the floor request is generated and may be set based on information related to a running time (for example, about 6 seconds) of a timer T100 and the number of running of the timer T100 (for example, about one time) identified in C100.

According to an embodiment, the electronic device 101 may determine whether the multicast scheme can be continuously used based on a loss rate of data (or media packets) received from the MCPTT server through the multicast scheme. For example, when the loss rate of the data (or media packets) received from the MCPTT server for a predetermined third time exceeds a predetermined reference loss rate, the electronic device 101 may determine that the multicast scheme cannot be continuously used. For example, the predetermined third time may include a reference time for detecting the loss rate of the data received from the MCPTT server.

According to various embodiments, when it is determined that the multicast scheme cannot be continuously used (for example, 222 of FIG. 2 or 302 of FIG. 3), the electronic device 101 may transmit a message related to switching to the unicast scheme to the MCPTT server. For example, the message related to switching to the unicast scheme may be transmitted to the MCPTT server in the form of a session initiation protocol (SIP) message. For example, the message related to switching to the unicast scheme may include a listening status report message including information of “not-listening”. For example, the listening status report message may include a MBMS bearer listening status report message.

According to various embodiments, the MCPTT server may transmit data (for example, media packets) to the electronic device 101 through the unicast scheme, based on reception of the message related to switching to the unicast scheme.

According to various embodiments, when it is determined that the electronic device 101 escapes the first service area 200 in the state in which the switching to the unicast scheme is performed as indicated by reference numeral 224, the electronic device 101 may maintain communication of the unicast scheme with the MCPTT server. According to an embodiment, when system information block (SIB) 13 is not received, the electronic device 101 may determine that the electronic device 101 escapes the first service area 200. The electronic device 101 may receive data (or media packets) from the MCPTT server through the unicast scheme in a second service area 210 that does not support the MBMS function.

According to various embodiments, when the GPMS with the MCPTT server is maintained in the state in which the switching to the unicast scheme is performed, the electronic device 101 may periodically receive a control message related to the MBMS subchannel from the MCPTT server through the GPMS, based on the predetermined second period. The electronic device 101 may determine whether the multicast scheme can be used based on reception status information of the control message related to the MBMS subchannel.

According to an embodiment, the electronic device 101 may determine whether the multicast scheme can be used based on a reception delay time of the control message related to the MBMS subchannel which is periodically transmitted by the MCPTT server, based on the predetermined second period. For example, when the reception delay time of the control message related to the MBMS subchannel that exceeds the predetermined reference delay time is not continuously detected by a predetermined first reference number, the electronic device 101 may determine that the electronic device 101 is located in a strong electric field (or medium electric field) area of the first service area 200 as indicated by reference numeral 304. When it is determined that the electronic device 101 is located in the strong electric field of the first service area 200 as indicated by reference numeral 304, the probability that the electronic device 101 escapes the first service area 200 is relatively low, and thus it may be determined that the multicast scheme can be used.

According to an embodiment, the electronic device 101 may determine whether the multicast scheme can be used based on the number of receptions of the control message related to the MBMS subchannel for a predetermined first time. For example, when the number of receptions of the control message related to the MBMB subchannel for the predetermined first time exceeds a predetermined second reference number, the electronic device 101 may determine that the multicast scheme can be used.

According to various embodiments, when it is determined that the multicast scheme can be used (for example, 304 of FIG. 3), the electronic device 101 may transmit a message related to switching to the multicast scheme to the MCPTT server. For example, the message related to the switching to the multicast scheme may be transmitted to the MCPTT server in the form of an SIP message. For example, the message related to the switching to the multicast scheme may include a listening status report message including information of “listening”. For example, the listening status report message may include a MBMS bearer listening status report message.

According to various embodiments, the MCPTT server may transmit data (for example, media packets) to the electronic device 101 through the multicast scheme, based on reception of the message related to the switching to the multicast scheme.

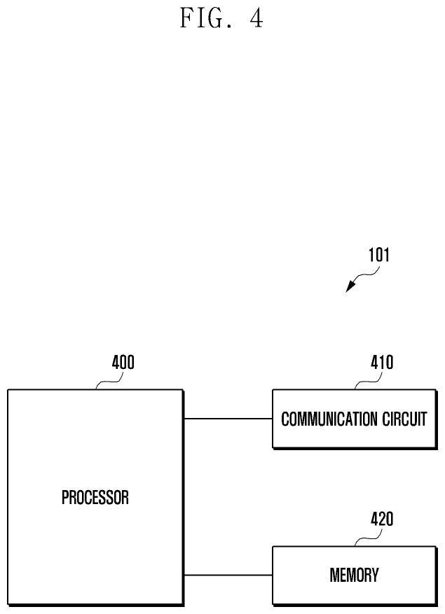

FIG. 4 is a block diagram of the electronic device for the MCPTT function according to an embodiment of the disclosure.

For example, the electronic device 101 of FIG. 4 may be at least partially similar to the electronic device 101 of FIG. 1 or may include another embodiment of the electronic device.

Referring to FIG. 4, the electronic device 101 may include a processor (e.g., including processing circuitry) 400, a communication circuit (or communication circuitry) 410, and/or memory 420. According to an embodiment, the processor 400 may be substantially the same as the processor 120 of FIG. 1 or may be included in the processor 120. The communication circuit 410 may be substantially the same as the wireless communication module 192 of FIG. 1 or included in the wireless communication module 192. The memory 420 may be substantially the same as the memory 130 of FIG. 1 or may be included in the memory 130. According to an embodiment, the processor 400 may be operatively, functionally, and/or electrically connected to the communication circuit 410 and/or the memory 420.

According to various embodiments, the processor 400 may control the communication circuit 410 to allow the electronic device 101 to access (or register in) the MCPTT server. According to an embodiment, the processor 400 may identify an account and/or a password related to the MCPTT function, based on execution of an application program related to the MCPTT function. For example, the account and/or the password related to the MCPTT function may be acquired based on a user input. For example, the account and/or the password related to the MCPTT function may be acquired by a subscriber identity module (SIM) of the electronic device 101.

According to an embodiment, when logging in the MCPTT server, based on the account and/or the password related to the MCPTT function, the processor 400 may acquire information related to access to (or registration in) the MCPTT server. The processor 400 may control the communication circuit 410 to access (or register in) the MCPTT server, based on information related to access to (or registration in) the MCPTT server. For example, the access to (or registration in) the MCPTT server may include a series of operations in which the electronic device 101 establishes a communication link with the MCPTT server corresponding to a network entity through the BS.

According to an embodiment, when accessing (or registering in) the MCPTT server, the processor 400 may control the communication circuit 410 to periodically transmit location information (for example, a location report message) to the MCPTT server, based on a predetermined first period. For example, the location information may include at least one of a service area identity (SAI) or an e-utran cell global identifier (ECGI).

According to an embodiment, the processor 400 may control the communication circuit 410 to transmit information related to an MCPTT group call to the MCPTT server to establish the MCPTT group call, based on generation of an event related to the start of the group call. When receiving a response signal (for example, 200 OK) corresponding to information related to the MCPTT group call from the MCPTT server through the communication circuit 410, the processor 400 may determine that the MCPTT group call is established. For example, the event related to the start of the group call may be generated based on at least one of execution of an application related to the group call, selection of an icon related to the group call, or a user input related to the group call. For example, the icon related to the group call may include an icon related to each group call in which the electronic device 101 can participate, included in a group call list displayed on a display of the electronic device 101. For example, the group call list is information related to at least one group call in which the electronic device 101 can participate and may be acquired (or determined) based on the account of the electronic device 101.

According to various embodiments, the processor 400 may control the communication circuit 410 to generate a general purpose MBMS subchannel (GPMS) of the MCPTT server, based on reception of the information related to the multimedia broadcast multicast service (MBMS) function from the MCPTT server through the communication circuit 410. According to an embodiment, when the MCPTT group call is established in the state in which the access to the MCPTT server is performed, the processor 400 may receive the information related to the multimedia broadcast multicast service (MBMS) function from the MCPTT server through the communication circuit 410. According to an embodiment, when a temporary mobile group identity (TMGI) identified in the information related to the MBMS function matches a TMGI of the service area (for example, the first service area 200 of FIG. 2 or 3) in which the electronic device 101 is located, the processor 400 may control the communication circuit 410 to generate (or establish) the GPMS with the MCPTT server, based on information related to the generation of the GPMS identified in the information related to the MBMD function. For example, the information related to the MBMS function is an announcement message and may include information related to the MBMS service area (for example, the first service area 200 of FIG. 2 or 3), information (for example, SDP MIME body) related to the generation of the GPMS, and/or a temporary mobile group identity (TMGI).

According to various embodiments, when a control message related to the MBMS subchannel is received from the MCPTT server through the GPMS, the processor 400 may generate a floor control channel and a media channel for multicast, based on the information related to the generation of the MBMS subchannel identified in the control message. For example, the control message related to the MBMS subchannel may be periodically received from the MCPTT server, based on a predetermined second period. For example, the predetermined second period is a running time of a timer T16 and may be acquired from service configuration information obtained from a configuration management server (CMS) at a time point at which logging in the MCPTT server is performed. For example, the control message related to the MBMS subchannel may include a map group to bearer message including information related to the generation of the MBMS subchannel. For example, the information related to the generation of the MBMS subchannel may include a floor control port number (for example, a floor control port number) and/or a media port number (for example, a media port number).

According to an embodiment, the processor 400 may control the communication circuit 410 to transmit a message related to switching to the multicast scheme to the MCPTT server, based on reception of the control message related to the MBMS subchannel. For example, the message related to the switching to the multicast scheme is a listening status report message including information of “listening” and may be transmitted to the MCPTT server through the unicast scheme in the form of a session initiation protocol (SIP) message. According to an embodiment, the electronic device 101 may receive data (for example, media packets) from the MCPTT server through the multicast scheme, based on transmission of the message related to the switching to the multicast scheme. For example, the electronic device 101 may receive data through a media channel for multicast generated based on the control message related to the MBMS subchannel.

According to various embodiments, when receiving data from the MCPTT server through the multicast scheme, the processor 400 may determine whether the multicast scheme can be continuously used. According to an embodiment, the processor 400 may determine whether the multicast scheme can be continuously used based on a reception delay time of the control message related to the MBMS subchannel which is periodically transmitted by the MCPTT server, based on a predetermined second period. For example, when the reception delay time of the control message related to the MBMS subchannel which exceeds a predetermined reference delay time is continuously detected by a predetermined first reference number, the processor 400 may determine that the electronic device 101 is located at the edge (or in the weak electric field) of the first service area 200. The processor 400 may determine that the electronic device 101 is located at the edge of the first service area 200 and thus the probability that the electronic device 101 escapes the first service area 200 is relatively high, and may determine that the multicast scheme cannot be continuously used. For example, the reception delay time of the control message related to the MBMS subchannel may include difference between a time point at which the control message related to the MBMS subchannel received at a previous time point (for example, a time point of n−1) is received and a time point at which the control message related to the MBMS subchannel received at the current time point (for example, a time point of n) us received. For example, the reception delay time of the control message related to the MBMS sub channel may include an elapsed time from a time point (for example, the predetermined second period) at which the control message related to the MBMS sub channel is received from the MCPTT server to a time point at which the control message related to the MBMS sub channel is received.

According to an embodiment, the processor 400 may determine whether the multicast scheme can be continuously used based on the number of receptions of the control message related to the MBMS subchannel for a predetermined first time. For example, when the number of receptions of the control message related to the MBMS subchannel for the predetermined first time is equal to or smaller than a predetermined second reference number, the processor 400 may determine that the multicast scheme cannot be continuously used. For example, the predetermined first time may include a reference time configured to identify the number of receptions of the control message related to the MBMS subchannel in order to determine whether the multicast scheme is used.

According to an embodiment, when timeout related to a floor request is generated, the processor 400 may determine that the multicast scheme cannot be continuously used. For example, the timeout related to the floor request may be generated when the electronic device 101 does not acquire the floor request after a second time from a time point at which the floor request message is transmitted to secure the floor. For example, the predetermined second time is a predetermined reference time to determine whether the timeout related to the floor request is generated and may be set based on information related to a running time (for example, about 6 seconds) of a timer T100 and the number of running of the timer T100 (for example, about one time) identified in C100.

According to an embodiment, the processor 400 may determine whether the multicast scheme can be continuously used based on a loss rate of data (or media packets) received from the MCPTT server through the multicast scheme. For example, when the loss rate of the data (or media packets) received from the MCPTT server for a predetermined third time exceeds a predetermined reference loss rate, the processor 400 may determine that the multicast scheme cannot be continuously used. For example, the predetermined third time may include a reference time for detecting the loss rate of the data received from the MCPTT server.

According to various embodiments, when it is determined that the multicast scheme cannot be continuously used, the processor 400 may control the communication circuit 410 to transmit a message related to switching to the unicast scheme to the MCPTT server. For example, the message related to the switching to the unicast scheme may be transmitted to the MCPTT server through the unicast scheme in the form of an SIP message. For example, the message related to switching to the unicast scheme may include a listening status report message including information of “not-listening”. According to an embodiment, the electronic device 101 may receive data (for example, media packets) from the MCPTT server through the unicast scheme, based on transmission of the message related to the switching to the unicast scheme.

According to various embodiments, the processor 400 may identify whether the electronic device 101 escapes the service area (for example, the first service area 200 of FIG. 2 or 3) supporting the MBMS function in the state in which the switching to the unicast scheme is performed. According to an embodiment, when system information block (SIB) 13 is not received, the processor 400 may determine that the electronic device 101 escapes the first service area 200 supporting the MBMS function. When the electronic device 101 escapes the service area supporting the MBMS function and is located in the service area (for example, the second service area 210 of FIG. 2 or 3) that does not support the MBMS function, the processor 400 may maintain communication of the unicast scheme with the MCPTT server. For example, the processor 400 may receive data from the MCPTT server through the unicast scheme in the service area (for example, the second service area 210 of FIG. 2 or 2) that does not support the MBMS function through the communication circuit 410.

According to various embodiments, when the electronic device 101 maintains the GPMS with the MCPTT server in the state in which the switching to the unicast scheme is performed, the processor 400 may periodically receive the control message related to the MBMS subchannel from the MCPTT server through the GPMS, based on the predetermined second period. The processor 400 may determine whether the multicast scheme can be used based on reception status information of the control message related to the MBMS subchannel.

According to an embodiment, the processor 400 may determine whether the multicast scheme can be used based on a reception delay time of the control message related to the MBMS subchannel which is periodically transmitted by the MCPTT server, based on the predetermined second period. For example, when the reception delay time of the control message related to the MBMS subchannel that exceeds the predetermined reference delay time is not continuously detected by a predetermined first reference number, the processor 400 may determine that the electronic device 101 is located in a strong electric field (or medium electric field) area (for example, 220 of FIG. 2 or 300 of FIG. 3) of the first service area 200. When it is determined that the electronic device 101 is located in the strong electric field of the first service area 200, the processor 400 may determine that the multicast scheme can be used since the probability that the electronic device 101 escapes the first service area 200 is relatively low. For example, when the reception delay time of the control message related to the MBMS subchannel that exceeds the predetermined reference delay time is continuously detected by the predetermined first reference number, the processor 400 may determine that the electronic device 101 is located in a weak electric field (for example, 222 of FIG. 2 or 302 of FIG. 3) of the first service area 200. When it is determined that the electronic device is located in the weak electric field of the first service area 200, the processor 400 may determine that the multicast scheme cannot be used since the probability that the electronic device 101 escapes the first service area 200 is relatively high. For example, the electronic device 101 may maintain data reception of the unicast scheme from the MCPTT server, based on determination that the multicast scheme cannot be used.

According to an embodiment, the processor 400 may determine whether the multicast scheme can be used based on the number of receptions of the control message related to the MBMS subchannel for a predetermined first time. For example, when the number of receptions of the control message related to the MBMB subchannel for the predetermined first time exceeds a predetermined second reference number, the processor 400 may determine that the multicast scheme can be used. For example, when the number of receptions of the control message related to the MBMS subchannel for the predetermined first time is equal to or smaller than the predetermined second reference number, the processor 400 may determine that the multicast scheme cannot be used. For example, the electronic device 101 may maintain data reception of the unicast scheme from the MCPTT server, based on determination that the multicast scheme cannot be used.

According to various embodiments, when it is determined that the multicast scheme can be used, the processor 400 may control the communication circuit 410 to transmit the message related to the switching to the multicast scheme to the MCPTT server. For example, the message related to the switching to the multicast scheme may be transmitted to the MCPTT server through the unicast scheme in the form of an SIP message, based on reception of the control message related to the MBMS subchannel. For example, the message related to the switching to the multicast scheme may include a listening status report message including information of “listening”.

According to an embodiment, the electronic device 101 may receive data (for example, media packets) from the MCPTT server through the multicast scheme, based on transmission of the message related to the switching to the multicast scheme. For example, the electronic device 101 may receive data through a media channel for multicast generated based on the control message related to the MBMS subchannel.

According to various embodiments, the communication circuit 410 may allow the electronic device 101 to transmit and/or receive signals and/or data to and/or from at least one external electronic device (for example, the electronic device 102 or 104 of FIG. 1 or the server 108). According to an embodiment, the communication circuit 410 may receive data from the MCPTT server through the unicast scheme or the multicast scheme. According to an embodiment, the communication circuit 410 may transmit data to the MCPTT server through the unicast scheme. For example, the communication circuit 410 may include a radio frequency integrated circuit (RFIC) and/or a radio frequency front end (RFFE) for communication with at least one external electronic device.

According to various embodiments, the memory 420 may store various pieces of data used by at least one element (for example, the processor 400 and/or the communication circuit 410) of the electronic device 101. According to an embodiment, the memory 420 may store various instructions which can be executed through the processor 400.

According to various embodiments, an electronic device (for example, the electronic device 101 of FIG. 1, 2, 3, or 4) may include a communication circuit (for example, the wireless communication module 192 of FIG. 1 or the communication circuit 410 of FIG. 4) and at least one processor (for example, the processor 120 of FIG. 1 or the processor 400 of FIG. 4) operatively connected to the communication circuit. According to an embodiment, the processor may establish a group call with a mission critical push to talk (MCPTT) server. According to an embodiment, the processor may establish at least one multimedia broadcast and multicast service (MBMS) subchannel with the MCPTT server through the communication circuit. According to an embodiment, the processor may identify a reception delay time of a control message related to an MBMS subchannel received through a general purpose MBMS subchannel (GPMS) in a state where the at least one MBMS subchannel is established. According to an embodiment, when the reception delay time of the control message related to the MBMS subchannel satisfies a predetermined first switching condition, the processor may transmit a message related to switching to a unicast scheme to the MCPTT server.

According to various embodiments, the at least one processor may establish the GPMS, based on information related to an MBMS function received from the MCPTT server through the communication circuit. According to an embodiment, the at least one processor may identify information related to generation of the MBMS subchannel in the control message related to the MBMS subchannel received through the GPMS. According to an embodiment, the at least one processor may establish at least one MBMS subchannel, based on the information related to the generation of the MBMS subchannel.

According to various embodiments, the at least one processor may acquire information related to the MBMS function from an announcement message received from the MCPTT server.

According to various embodiments, the control message related to the MBMS subchannel may include a map group to bearer message.

According to various embodiments, when the number of times the reception delay time of the control message related to the MBMS subchannel exceeds a predetermined reference delay time continuously exceeds a predetermined first reference number, the at least one processor may determine that the predetermined first switching condition is satisfied.

According to various embodiments, the MBMS subchannel may include a floor control channel and a media channel related to multicast. According to an embodiment, the at least one processor may receive data from the MCPTT server through the media channel.

According to various embodiments, the at least one processor may transmit a floor request signal through a floor control channel. According to an embodiment, when a response signal related to the floor request signal is not received for a predetermined first reference time, the at least one processor may transmit the message related to switching to the unicast scheme to the MCPTT server.

According to various embodiments, the at least one processor may identify a loss rate of data received through the media channel for a predetermined second reference time. According to an embodiment, when the loss rate of the data exceeds a predetermined reference loss rate, the at least one processor may transmit the message related to switching to the unicast scheme to the MCPTT server.

According to various embodiments, the message related to switching to the unicast scheme may include a listening status report related to not-listening.

According to various embodiments, the at least one processor may identify the reception delay time of the control message related to the MBMS subchannel received through the GPMS after the message related to switching to the unicast scheme is transmitted. According to an embodiment, when the reception delay time of the control message related to the MBMS subchannel satisfies a predetermined second switching condition, the at least one processor may transmit the message related to switching to the multicast scheme to the MCPTT server.

According to various embodiments, when the number of times the reception delay time of the control message related to the MBMS subchannel exceeds a predetermined reference delay time does not continuously exceed a predetermined first reference number, the at least one processor may determine that the predetermined second switching condition is satisfied.

According to various embodiments, the message related to switching to the multicast scheme may include a listening status report related to listening.

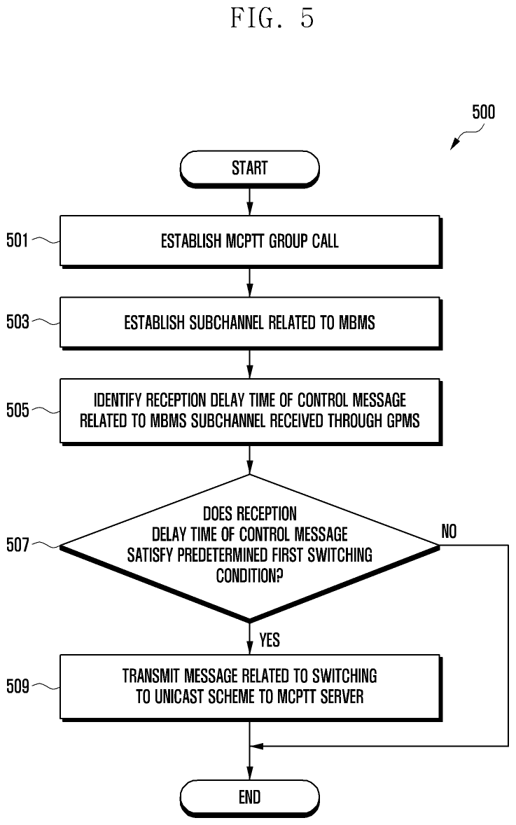

FIG. 5 is a flowchart illustrating a process through which the electronic device provides the MCPTT function according to an embodiment of the disclosure.

In the following embodiments, respective operations may be sequentially performed but the sequential performance is not necessary. For example, orders of the operations may be changed, and at least two operations may be performed in parallel. For example, the electronic device of FIG. 5 may be the electronic device 101 of FIG. 1, 2, 3, or 4.

Referring to FIG. 5, an electronic device 101 may provide a MCPTT function via a process 500. The electronic device (for example, the processor 120 of FIG. 1 or the processor 400 of FIG. 4) may establish a group call with the MCPTT server in operation 501. According to an embodiment, the processor 400 may acquire an account and/or a password related to the MCPTT function, based on execution of an application program related to the MCPTT function. For example, the account and/or the password related to the MCPTT function may be acquired based on a user input. For example, the account and/or the password related to the MCPTT function may be acquired by a SIM of the electronic device 101. According to an embodiment, when logging in the MCPTT server, based on the account and/or the password related to the MCPTT function, the processor 400 may acquire information related to access to (or registration in) the MCPTT server. The processor 400 may control the communication circuit 410 to access (or register in) the MCPTT server, based on information related to access to (or registration in) the MCPTT server. For example, the access to (or registration in) the MCPTT server may include a series of operations in which the electronic device 101 establishes a communication link with the MCPTT server corresponding to a network entity through the BS. According to an embodiment, the processor 400 may control the communication circuit 410 to transmit information related to an MCPTT group call to the MCPTT server to establish the MCPTT group call, based on generation of an event related to the start of the group call in the state in which the access to (or registration in) the MCPTT server is performed. When receiving a response signal (for example, 200 OK) corresponding to information related to the MCPTT group call from the MCPTT server through the communication circuit 410, the processor 400 may determine that the MCPTT group call is established. For example, the establishment of the MCPTT group call may include a series of operations for establishing a group session for the MCPTT group call.

According to an embodiment, when accessing (or registering in) the MCPTT server, the processor 400 may control the communication circuit 410 to periodically transmit location information (for example, a location report message) to the MCPTT server, based on a predetermined first period.

According to various embodiments, the electronic device (for example, the processor 120 or 400) may establish a subchannel related to the MBMS, based on a control message related to an MBMS subchannel acquired from the MCPTT server in operation 503. According to an embodiment, the processor 400 may control the communication circuit 410 to generate a general purpose MBMS subchannel (GPMS) of the MCPTT server, based on reception of the information related to the MBMS function from the MCPTT server through the communication circuit 410. According to an embodiment, when receiving the control message related to the MBMS subchannel from the MCPTT server through the GPMS, the processor 400 may control the communication circuit 410 to generate the subchannel related to the MBMS, based on information related to the generation of the MBMS subchannel identified in the control message. For example, the subchannel related to the MBMS may include a floor control channel for multicast (for example, a multicast floor subchannel) and a media channel for multicast (for example, a multicast media channel). For example, the control message related to the MBMS subchannel may include a map group to bearer message including the information related to the generation of the MBMS subchannel. For example, the information related to the generation of the MBMS subchannel may include a floor control port number (for example, a floor control port number) and/or a media port number (for example, a media port number).

According to an embodiment, the processor 400 may control the communication circuit 410 to transmit a message related to switching to the multicast scheme to the MCPTT server, based on reception of the control message related to the MBMS subchannel. For example, the message related to the switching to the multicast scheme is a listening status report message including information of “listening” and may be transmitted to the MCPTT server through the unicast scheme in the form of an SIP message. According to an embodiment, the electronic device 101 may receive data (for example, media packets) from the MCPTT server through the MBMS subchannel in the multicast scheme, based on transmission of the message related to the switching to the multicast scheme.

According to various embodiments, the electronic device (for example, the processor 120 or 400) may identify a reception delay time of the control message related to the MBMS subchannel received through the GPMS in the state in which the multicast scheme from the MCPTT server is configured in operation 505. For example, the reception delay time of the control message related to the MBMS sub channel may include difference between a time point of the control message related to the MBMS sub channel received at a previous time point (for example, a time point of n−1) is received and a time point of the control message related to the MBMS sub channel received at the current time point (for example, a time point of n) is received. For example, the reception delay time of the control message related to the MBMS sub channel may include an elapsed time from a time point (for example, the predetermined second period) at which the control message related to the MBMS sub channel is received from the MCPTT server to a time point at which the control message related to the MBMS sub channel is received.

According to various embodiments, the electronic device (for example, the processor 120 or 400) may identify whether the reception delay time of the control message related to the MBMS subchannel satisfies a predetermined first switching condition in operation 507. According to an embodiment, when the reception delay time of the control message related to the MBMS subchannel that exceeds a predetermined reference delay time is continuously detected by a predetermined first reference number, the processor 400 may determine that the predetermined first switching condition is satisfied. For example, states in which the predetermined first switching condition is satisfied may include a state in which it is determined that the multicast scheme cannot be continuously used because the electronic device 101 is located at the edge (or in the weak electric field area) (for example, 222 of FIG. 2 or 302 of FIG. 3) of the first service area 200 and thus it is determined that the probability that the electronic device escapes the first service area 200 is relatively high. According to an embodiment, when the reception delay time of the control message related to the MBMS subchannel that exceeds the predetermined reference delay time is not continuously detected by the predetermined first reference number, the processor 400 may determine that the predetermined first switching condition is not satisfied. For example, states in which the predetermined first switching condition is not satisfied may include a state in which it is determined that the multicast scheme can be continuously used because the electronic device 101 is located in the strong electric field (or medium electric field area) (for example, 220 of FIG. 2 or 300 of FIG. 3) of the first service area 200 and thus it is determined that the probability that the electronic device escapes the first service area 200 is relatively low.

According to various embodiments, when it is determined that the reception delay time of the control message related to the MBMS subchannel satisfies the first predetermined first switching condition (for example, “Yes” of operation 507), the electronic device (for example, the processor 120 or 400) may transmit a message related to switching to the unicast scheme to the MCPTT server in operation 509. For example, the message related to the switching to the unicast scheme is a listening status report message including information of “not-listening” and may be transmitted to the MCPTT server through the unicast scheme in the form of an SIP message. According to an embodiment, the electronic device 101 may receive data (for example, media packets) from the MCPTT server through the unicast scheme, based on transmission of the message related to the switching to the unicast scheme.

According to various embodiments, when it is determined that the reception delay time of the control message related to the MBMS subchannel does not satisfy the first predetermined first switching condition (for example, “No” of operation 507), the electronic device (for example, the processor 120 or 400) may end an embodiment for providing the MCPTT function. According to an embodiment, when it is determined that the reception delay time of the control message related to the MBMS subchannel does not satisfy the first predetermined first switching condition, the processor 400 may determine that the multicast scheme from the MCPTT server can be maintained. For example, the electronic device 101 may receive data (for example, media packets) from the MCPTT server through the MBMS subchannel in the multicast scheme.

According to various embodiments, the predetermined reference delay time for determining whether the multicast scheme can be used by the electronic device 101 may be configured based on a transmission period (for example, a predetermined second period) of the control message related to the MBMS subchannel. For example, the predetermined second period may correspond to a running time of a timer T16 acquired from service configuration information obtained from a CMS at a time point at which logging in the MCPTT server is performed. According to an embodiment, the predetermined reference delay time may be configured as A times (for example, about 1.5 times) of the predetermined second period. According to an embodiment, when a reference reception signal strength (for example, reference signals received power (RSRP)) acquired from the MCPTT server is larger than or equal to a first reference strength (for example, about −85 dBm), the predetermined reference delay time may be configured as A times (for example, about 1.5 times) of the predetermined second period. When the reference reception signal strength (for example, RSRP) acquired from the MCPTT server is smaller than the first reference strength and larger than or equal to a second reference strength (for example, about −100 dBm), the predetermined reference delay time may be configured as B times (for example, about 2 times) of the predetermined second period. When the reference reception signal strength (for example, RSRP) acquired from the MCPTT server is smaller than a third reference strength (for example, about −120 dBm), the predetermined reference delay time may be configured as C times (for example, about 2.5 times) of the predetermined second period. For example, a reception signal strength is a reception signal strength that is the reference to distinguish the strong electric field (or medium electric field) area and the weak electric field area within the service area of the MCPTT server by the electronic device 101, and may be included in a response signal to location information (for example, location report message) received from the MCPTT server. According to an embodiment, when the predetermined second period is equal to or smaller than a first reference time (for example, about 500 ms), the predetermined reference delay time may be configured as D times (for example, 3 times) of the predetermined second period. When the predetermined second period is larger than the first reference time and is equal to or smaller than the second reference time (for example, about 1000 ms), the predetermined reference delay time may be configured as B times (for example, about 2 times) of the predetermined second period. When the predetermined second period is larger than the second reference time and is equal to or smaller than a third reference time (for example, about 5000 ms), the predetermined reference delay time may be configured as A times (for example, about 1.5 times) of the predetermined second period.

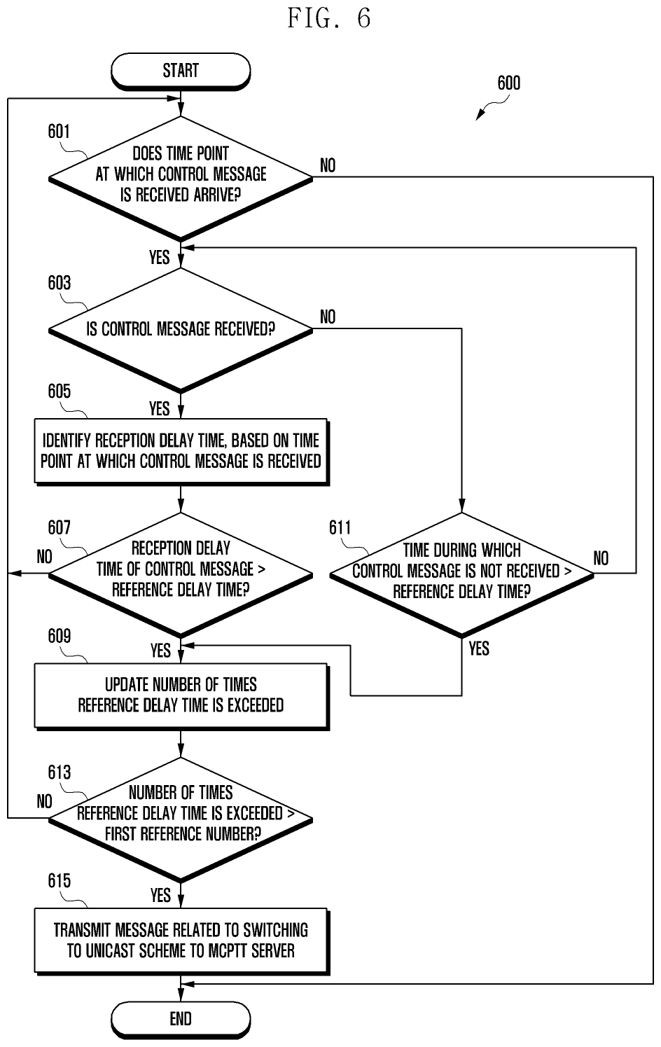

FIG. 6 is a flowchart illustrating a process in which the electronic device switches to the unicast scheme, based on a reception delay time of a control message according to an embodiment of the disclosure.

According to an embodiment, at least some of a process 600 illustrated in FIG. 6 may include detailed operations of operations 507 to 511 of FIG. 5. In the following embodiments, respective operations may be sequentially performed but the sequential performance is not necessary. For example, orders of the operations may be changed, and at least two operations may be performed in parallel. For example, the electronic device of FIG. 6 may be the electronic device 101 of FIG. 1, 2, 3, or 4.

Referring to FIG. 6, the electronic device (for example, the processor 120 of FIG. 1 or the processor 400 of FIG. 4) may identify whether the time point at which the control message related to the MBMS subchannel is received arrives in operation 601. For example, the time point at which the control message related to the MBMS subchannel is received may correspond to a running time of the timer T16. For example, the running time of the timer T16 and may be acquired from service configuration information obtained from a configuration management server (CMS) at a time point at which logging in the MCPTT server is performed.

According to various embodiments, when the time point at which the control message related to the MBMS subchannel is received does not arrive (for example, “No” of operation 601), the electronic device (for example, the processor 120 or 400) may end an embodiment for switching to the unicast scheme, based on the reception delay time of the control message.

According to various embodiments, when the time point at which the control message related to the MBMS subchannel is received arrives (for example, “Yes” of operation 601), the electronic device (for example, the processor 120 or 400) may identify whether the control message related to the MBMS subchannel is received from the MCPTT server in operation 603.

According to various embodiments, when receiving the control message related to the MBMS subchannel (for example, “Yes” of operation 603), the electronic device (for example, the processor 120 or 400) may identify the reception delay time of the control message related to the MBMS subchannel, based on the time point at which the control message related to the MBMS subchannel is received in operation 605. For example, the reception delay time of the control message related to the MBMS sub channel may include difference between a time point of the control message related to the MBMS sub channel received at a previous time point (for example, a time point of n−1) is received and a time point of the control message related to the MBMS sub channel received at the current time point (for example, a time point of n) is received. For example, the reception delay time of the control message related to the MBMS sub channel may include an elapsed time from a time point (for example, the predetermined second period) at which the control message related to the MBMS sub channel is received from the MCPTT server to a time point at which the control message related to the MBMS sub channel is received.

According to various embodiments, the electronic device (for example, the processor 120 or 400) may identify whether the reception delay time of the control message related to the MBMS subchannel exceeds a predetermined reference delay time in operation 607. For example, the predetermined reference delay time may include a reference value for determining whether the electronic device 101 is located in the weak electric field area, based on the reception delay time of the control message related to the MBMS subchannel.

According to various embodiments, when the reception delay time of the control message related to the MBMS subchannel is equal to or smaller than the predetermined reference delay time (for example, “No” of operation 607), the electronic device (for example, the processor 120 or 400) may identify whether the time at which the control message related to the MBMS subchannel is received arrives in operation 601. According to an embodiment, the processor 400 may initialize the number of times the reference delay time is exceeded based on detection of the reception delay time of the control message related to the MBMS subchannel equal to or smaller than the reference delay time.

According to various embodiments, when the reception delay time of the control message related to the MBMS subchannel exceeds the predetermined reference delay time (for example, “Yes” of operation 607), the electronic device (for example, the processor 120 or 400) may update the number of times the reference delay time is exceeded in operation 609. According to an embodiment, the processor 400 may increase the number of times the reference delay time is exceeded by one step.

According to various embodiments, when the control message related to the MBMS subchannel is not received (for example, “No” of operation 603), the electronic device (for example, the processor 120 or 400) may identify whether the time during which the control message related to the MBMS subchannel is not received exceeds the predetermined reference delay time in operation 611. For example, the time during which the control message related to the MBMS subchannel is not received may include an elapsed time from the time point during which the control message related to the MBMS subchannel received at the previous time point (for example, the time point of n−1) is received to the current time point. For example, the time during which the control message related to the MBMS subchannel is not received may include an elapsed time from the time point (for example, a predetermined second period) at which the control message related to the MBMS subchannel is received from the MCPTT server to the current time point.

According to various embodiments, when the time during which the control message related to the MBMS subchannel is equal to or smaller than the predetermined reference delay time (for example, “No” of operation 611), the electronic device (for example, the processor 120 or 400) may identify whether the control message related to the MBMS subchannel is received from the MCPTT server in operation 603.

According to various embodiments, when the time during which the control message related to the MBMS subchannel exceeds the predetermined reference delay time (for example, “Yes” of operation 611), the electronic device (for example, the processor 120 or 400) may update the number of times the reference delay time is exceeded in operation 609. According to an embodiment, the processor 400 may increase the number of times the reference delay time is exceeded by one step.

According to various embodiments, the electronic device (for example, the processor 120 or 400) may identify whether the number of times the reference delay time is exceeded exceeds a predetermined first reference number in operation 613.

According to various embodiments, when the number of times the reference delay time is exceeded is equal to or smaller than the predetermined first reference number (for example, “No” of operation 613), the electronic device (for example, the processor 120 or 400) may identify whether the time point at which the control message related to the MBMS subchannel is received in operation 601.

According to various embodiments, when the number of times the reference delay time is exceeded exceeds the predetermined first reference number (for example, “Yes” of operation 613), the electronic device (for example, the processor 120 or 400) may transmit a message related to switching to the unicast scheme to the MCPTT server in operation 615. According to an embodiment, when the number of times the reference delay time is exceeded exceeds the predetermined first reference number, the processor 400 may determine that the electronic device 101 is located at the edge (or in the weak electric field area) of the service area (for example, the first service area 200 of FIG. 2 or 3) (222 or 302). The processor 400 may determine that the multicast scheme cannot be continuously used because the electronic device 101 is located at the edge of the service area and the probability that the electronic device escapes the service area is relatively high. The processor 400 may control the communication circuit 410 to transmit a message related to switching to the unicast scheme to the MCPTT server, based on determination that the multicast scheme cannot be continuously used. For example, states in which the number of times the reference delay time is exceeded exceeds the predetermined first reference number may include a state in which the reception delay time of the control message related to the MBMS subchannel that exceeds the predetermined reference delay time or the time during which the control message is not received is continuously detected by the predetermined first reference number. For example, the message related to the switching to the unicast scheme is a listening status report message including information of “not-listening” and may be transmitted to the MCPTT server through the unicast scheme in the form of an SIP message.

According to various embodiments, the electronic device 101 may receive data (for example, media packets) from the MCPTT server through the unicast scheme, based on transmission of the message related to the switching to the unicast scheme.

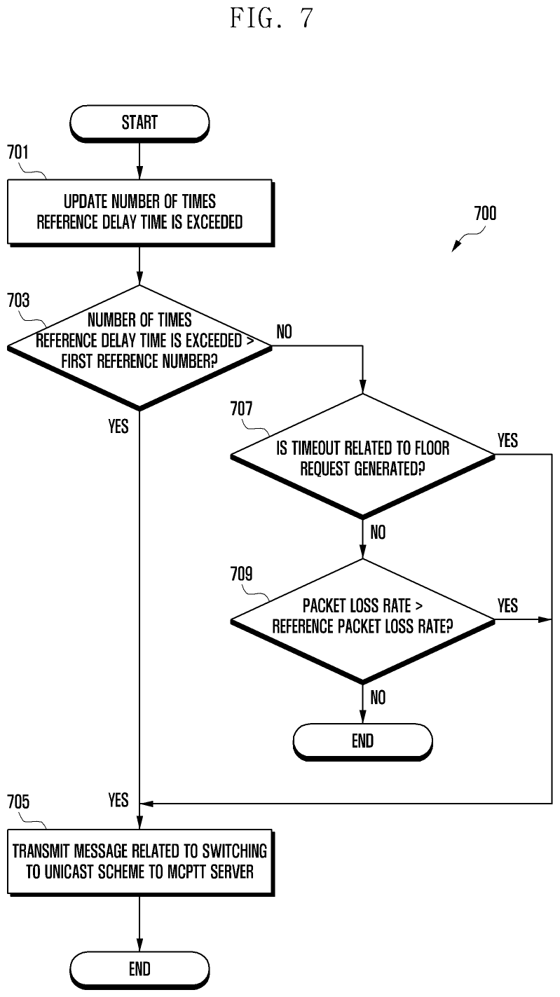

FIG. 7 is a flowchart illustrating a process in which the electronic device switches a communication scheme with the MCPTT server to the unicast scheme according to an embodiment of the disclosure.

According to an embodiment, at least some of a process 700 illustrated in FIG. 7 may include detailed operations of operations 609 and 613 of FIG. 6. In the following embodiments, respective operations may be sequentially performed but the sequential performance is not necessary. For example, orders of the operations may be changed, and at least two operations may be performed in parallel. For example, the electronic device of FIG. 7 may be the electronic device 101 of FIG. 1, 2, 3, or 4.

Referring to FIG. 7, when the reception delay time of the control message related to the MBMS subchannel or the time during which the control message is not received exceeds the predetermined reference delay time (for example, “Yes” of operation 607 or “Yes” of operation 611 in FIG. 6), the electronic device (for example, the processor 120 of FIG. 1 or the processor 400 of FIG. 4) may update the number of times the reference delay time is exceeded in operation 701. For example, the update of the number of times the reference delay time is exceeded may include a series of operations for increasing the number of times the reference delay time is exceeded by one step.

According to various embodiments, the electronic device (for example, the processor 120 or 400) may identify whether the number of times the reference delay time is exceeded exceeds a predetermined first reference number in operation 703.

According to various embodiments, when the number of times the reference delay time is exceeded exceeds the predetermined first reference number (for example, “Yes” of operation 703), the electronic device (for example, the processor 120 or 400) may transmit a message related to switching to the unicast scheme to the MCPTT server in operation 705. For example, the message related to the switching to the unicast scheme is a listening status report message including information of “not-listening” and may be transmitted to the MCPTT server through the unicast scheme in the form of an SIP message.

According to various embodiments, when the number of times the reference delay time is exceeded is equal to or smaller than the predetermined first reference number (for example, “No” of operation 703), the electronic device (for example, the processor 120 or 400) may identify whether timeout related to a floor request is generated in operation 707. For example, the timeout related to the floor request may be generated when the electronic device 101 does not acquire the floor through a floor control channel (for example, a multicast floor subchannel) for a predetermined second time from a time point at which a floor request message is transmitted to the MCPTT server to secure the floor. For example, the predetermined second time is a predetermined reference time to determine whether the timeout related to the floor request is generated and may be set based on information related to a running time (for example, about 6 seconds) of a timer T100 and the number of running of the timer T100 (for example, about one time) identified in C100.

According to various embodiments, when the timeout related to the floor request is generated (for example, “Yes” of operation 707), the processor 120 or 400 may transmit a message related to switching to the unicast scheme to the MCPTT server in operation 705. According to an embodiment, when timeout related to a floor request is generated, the processor 400 of electronic device 101 may determine that the multicast scheme cannot be continuously used. The processor 400 may control the communication circuit 410 to transmit a message related to switching to the unicast scheme to the MCPTT server, based on determination that the multicast scheme cannot be continuously used.

According to various embodiments, when the timeout related to the floor request is not generated (for example, “No” of operation 707), the electronic device (for example, the processor 120 or 400) may identify whether a loss rate of data (or media packets) received from the MPTT server through the multicast scheme exceeds a predetermined reference packet loss rate in operation 709. For example, the loss rate of the data may be measured for a predetermined third time. For example, the predetermined third time may include a reference time for detecting the loss rate of the data received from the MCPTT server.

According to various embodiments, when the loss rate of the data (or media packets) received from the MCPTT server through the multicast scheme exceeds the predetermined reference packet loss rate (for example, “Yes” of operation 709), the electronic device (for example, the processor 120 or 400) may transmit a message related to switching to the unicast scheme to the MCPTT server in operation 705. According to an embodiment, when the loss rate of the data (or media packets) received from the MCPTT server through the multicast scheme exceeds the predetermined reference packet loss rate, the processor 400 may determine that the multicast scheme cannot be continuously used. The processor 400 may control the communication circuit 410 to transmit a message related to switching to the unicast scheme to the MCPTT server, based on determination that the multicast scheme cannot be continuously used.

According to various embodiments, when the loss rate of the data (or media packets) received from the MCPTT server through the multicast scheme is equal to or smaller than the predetermined reference packet loss rate (for example, “No” of operation 709), the electronic device (for example, the processor 120 or 400) may end an embodiment for switching the communication scheme with the MCPTT server to the unicast scheme. According to an embodiment, when the timeout related to the floor request is not generated and/or when the loss rate of the data (or media packets) received from the MCPTT server through the multicast scheme is equal to or smaller than the predetermined reference packet loss rate, the processor 400 may determine that the multicast scheme can be continuously used. The processor 400 may identify whether the time point at which the control message related to the MBMB subchannel is received arrives in operation 601 of FIG. 6.

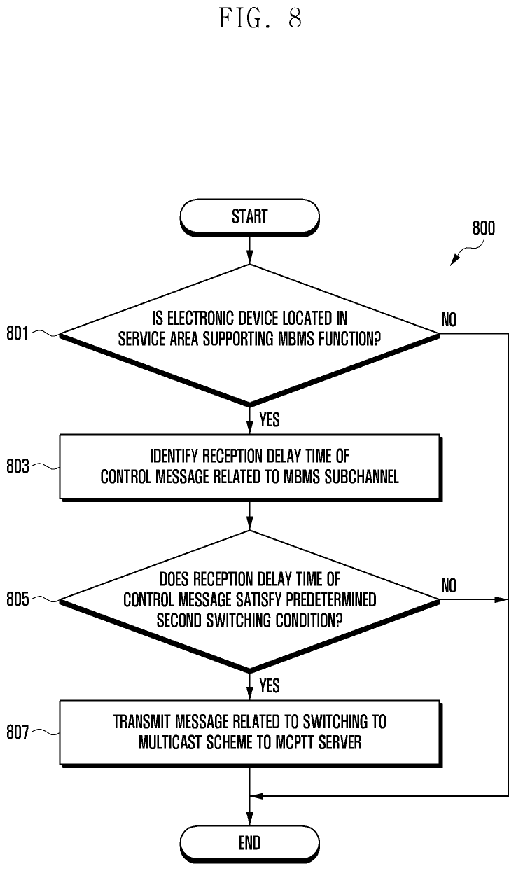

FIG. 8 is a flowchart illustrating a process in which the electronic device switches a communication scheme with the MCPTT server to the multicast scheme according to an embodiment of the disclosure.

In the following embodiments, respective operations may be sequentially performed but the sequential performance is not necessary. For example, orders of the operations may be changed, and at least two operations may be performed in parallel. For example, the electronic device of FIG. 8 may be the electronic device 101 of FIG. 1, 2, 3, or 4.

Referring to FIG. 8, an electronic device 101 may switch a communication scheme with the MCPTT server to the multicast scheme via process 800. When transmitting the message related to switching to the unicast scheme to the MCPTT server (For example, operation 509 of FIG. 5), the electronic device (for example, the processor 120 of FIG. 1 or the processor 400 of FIG. 4) may identify whether the electronic device 101 escapes the service area (for example, the first service area 200 of FIG. 2 or 3) supporting a multimedia broadcast multicast service (MBMS) function in operation 801. According to an embodiment, when system information block (SIB) 13 is not received through the communication circuit 410, the processor 400 may determine that the electronic device escapes the service area supporting the MBMS function. According to an embodiment, when SIB 13 is received through the communication circuit 410, the processor 400 may determine that the electronic device is located within the service area supporting the MBMS function.

According to various embodiments, when it is determined that the electronic device 101 escapes the service area supporting the MBMS function (for example, “No” of operation 801), the electronic device (for example, the processor 120 or 400) may end an embodiment for switching the communication scheme with the MCPTT server to the multicast scheme. According to an embodiment, when it is determined that the electronic device 101 escapes the service area supporting the MBMS function, the processor 400 may maintain the unicast communication scheme with the MCPTT server. For example, the unicast communication scheme with the MCPTT server may include a communication scheme in which the electronic device 101 receives data from the MCPTT server through the unicast scheme.

According to various embodiments, when it is determined that the electronic device 101 does not escape the service area supporting the MBMS function (for example, “Yes” of operation 801), the electronic device (for example, the processor 120 or 400) may identify the reception delay time of the control message related to the MBMS subchannel received through the GPMS in operation 803. For example, the GPMS with the MCPTT may be maintained when the electronic device 101 does not escapes the service area supporting the MBMS function. For example, the reception delay time of the control message related to the MBMS sub channel may include difference between a time point of the control message related to the MBMS sub channel received at a previous time point (for example, a time point of n−1) is received and a time point of the control message related to the MBMS sub channel received at the current time point (for example, a time point of n) is received. For example, the reception delay time of the control message related to the MBMS sub channel may include an elapsed time from a time point (for example, the predetermined second period) at which the control message related to the MBMS sub channel is received from the MCPTT server to a time point at which the control message related to the MBMS sub channel is received.

According to various embodiments, the electronic device (for example, the processor 120 or 400) may identify whether the reception delay time of the control message related to the MBMS subchannel satisfies a predetermined second switching condition in operation 805. According to an embodiment, when the reception delay time of the control message related to the MBMS subchannel that exceeds the predetermined reference delay time is not continuously detected by the predetermined first reference number, the processor 400 may determine that the predetermined second switching condition is satisfied. For example, states in which the predetermined second switching condition is satisfied may include a state in which it is determined that the multicast scheme can be used because the electronic device 101 is located in the strong electric field (or medium electric field) area (for example, 220 of FIG. 2 or 300 of FIG. 3) of the first service area 200 and thus it is determined that the probability that the electronic device escapes the first service area 200 is relatively low. According to an embodiment, when the reception delay time of the control message related to the MBMS subchannel that exceeds the predetermined reference delay time is continuously detected by the predetermined first reference number, the processor 400 may determine that the predetermined second switching condition is not satisfied. For example, states in which the predetermined second switching condition is not satisfied may include a state in which it is determined that the multicast scheme cannot be continuously used because the electronic device 101 is located in the weak electric field area (or at the edge) (for example, 222 of FIG. 2 or 302 of FIG. 3) of the first service area 200 and thus the probability that the electronic device escapes the first service area 200 is relatively high.

According to various embodiments, when it is determined that the reception delay time of the control message related to the MBMS subchannel satisfies the predetermined second switching condition (for example, “Yes” of operation 805), the electronic device (for example, the processor 120 or 400) may transmit a message related to switching to the multicast scheme to the MCPTT server in operation 807. For example, the message related to the switching to the multicast scheme is a listening status report message including information of “listening” and may be transmitted to the MCPTT server through the unicast scheme in the form of an SIP message. According to an embodiment, the electronic device 101 may receive data (for example, media packets) from the MCPTT server through the multicast scheme, based on transmission of the message related to the switching to the multicast scheme. For example, operations of receiving the data from the MCPTT server through the multicast scheme may include a series of operations of receiving data from the MCPTT server through the MBMS subchannel (for example, a media channel).

According to various embodiments, when it is determined that the reception delay time of the control message related to the MBMS subchannel does not satisfy the predetermined second switching condition (for example, “No” of operation 805), the electronic device (for example, the processor 120 or 400) may end an embodiment for switching the communication scheme with the MCPTT server to the multicast scheme.

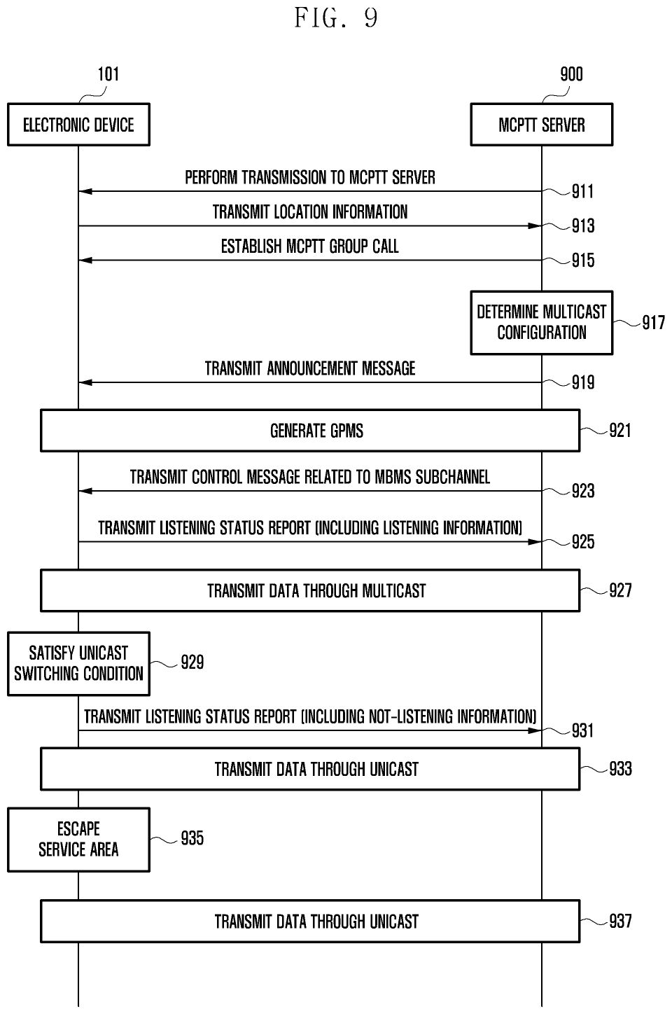

FIG. 9 illustrates an example for providing the MCPTT function by the electronic device according to an embodiment of the disclosure.

For example, the electronic device of FIG. 9 may be the electronic device 101 of FIG. 1, 2, 3, or 4.

Referring to FIG. 9, the electronic device 101 may access (or register in) an MCPTT server 900 in operation 911. According to an embodiment, the electronic device 101 may acquire an account and/or a password related to an MCPTT function, based on execution of an application program related to the MCPTT function. For example, the account and/or the password related to the MCPTT function may be acquired based on a user input. For example, the account and/or the password related to the MCPTT function may be acquired by a SIM of the electronic device 101. According to an embodiment, when the electronic device 101 logs in the MCPTT server 900, based on the account and/or password related to the MCPTT function, the electronic device 101 may acquire information related to the access to (or registration in) the MCPTT server 900 from a network (for example, a configuration management server (CMS)). The electronic device 101 may access (or register in) the MCPTT server 900, based on the information related to the access to (or registration in) the MCPTT server 900.

According to an embodiment, the electronic device 101 may acquire information related to a transmission period (for example, a predetermined second period) of a control message related to an MBMS subchannel from service configuration information obtained from the CMS at a time point of the login into the MCPTT server 900. For example, the information related to the transmission period (for example, the predetermined second period) of the control message related to the MBMS subchannel may include information related to a running time of a timer T 16. For example, the control message related to the MBMS subchannel may include a map group to bearer message including information related to the generation of the MBMS subchannel. For example, the information related to the generation of the MBMS subchannel may include a floor control port number (for example, a floor control port number) and/or a media port number (for example, a media port number).

According to various embodiments, when the electronic device 101 access (or register in) the MCPTT server 900 in order to provide the MCPTT function, the electronic device 101 may periodically transmit location information (for example, a location report message) to the MCPTT server 900, based on a predetermined first period in operation 913.

According to various embodiments, the electronic device 101 may establish an MCPTT group call with the MCPTT server 900, based on generation of an event related to the start of the group call in operation 915. According to an embodiment, the electronic device 101 may transmit information related to the MCPTT group call to the MCPTT server 900 in order to establish the MCPTT group call, based on the generation of the event related to the start of the group call. When receiving a response signal (for example, 200 OK) corresponding to the information related to the MCPTT group call from the MCPTT server, the electronic device 101 may determine that the MCPTT group call has been established. For example, the establishment of the MCPTT group call may include a series of operations for establishing a group session for the MCPTT group call. For example, the event related to the start of the group call may be generated based on at least one of execution of an application related to the group call, selection of an icon related to the group call, or a user input related to the group call.

According to various embodiments, when the number of electronic devices belonging to a specific group within a service area (for example, the first service area 200 of FIG. 2 or 3) supporting the MBMS function exceeds a predetermined reference number, the MCPTT server 900 may determine that the multicast scheme is used for the electronic devices belonging to the specific group within the service area in operation 917. According to an embodiment, the MCPTT server 900 may identify electronic devices 101 (or the number of electronic devices) located within the service area supporting the MBMS function, based on location information periodically received from the electronic device 101. According to an embodiment, the MCPTT server 900 may identify electronic devices 101 (or the number of electronic devices) which are making the group call within the specific group, based on the information related to the group call received from the electronic device 101.

According to various embodiments, the MCPTT server 900 may transmit information related to the MBMS function to the electronic devices 101 belonging to the specific group within the service area, based on determination that the multicast scheme is used in operation 919. For example, the information related to the MBMS function may include information related to generation of a general purpose MBMS subchannel (GPMS) and a temporary mobile group identity (TMGI).

According to various embodiments, the electronic device 101 may generate the GPMS with the MCPTT server 900, based on information related to the MBMS function received from the MCPTT server 900 in operation 921. According to an embodiment, when a TMGI identified in the information related to the MBMS function matches a TMGI of the service area (for example, the first service area 200 of FIG. 2 or 3) in which the electronic device 101 is located, the electronic device 101 may generate (or establish) the GPMS with the MCPTT server 900, based on information related to the generation of the GPMS identified in the information related to the MBMS function.

According to various embodiments, the MCPTT server 900 may periodically transmit a control message related to the MBMS subchannel through the GPMS, based on the predetermined second period in operation 923.

According to various embodiments, when receiving the control message related to the MBMS subchannel from the MCPTT server 900 through the GPMS in operation 923, the electronic device 101 may transmit a message related to switching to the multicast scheme to the MCPTT server 900 in operation 925. For example, the message related to the switching to the multicast scheme is a listening status report message including information of “listening” and may be transmitted to the MCPTT server 900 in the form of an SIP message. According to an embodiment, the electronic device 101 may generate a floor control channel and a media channel for multicast, based on information related to generation of the MBMS subchannel included in the control message related to the MBMS subchannel received from the MCPTT server 900 through the GPMS.

According to various embodiments, the MCPTT server 900 may transmit data (for example, media packets) to the electronic device 101 in a specific group located in a service area supporting the MBMS function through the multicast scheme, based on reception of the message related to switching to the multicast scheme in operation 927. For example, data of the multicast scheme may be transmitted through a media channel related to the multicast scheme.

According to various embodiments, when receiving data from the MCPTT server 900 through the multicast scheme, the electronic device 101 may determine whether the multicast scheme can be continuously used. According to an embodiment, the electronic device 101 may determine whether the multicast scheme can be continuously used based on a reception delay time of the control message related to the MBMS sub channel which is periodically transmitted by the MCPTT server 900, based on a predetermined second period. For example, when the reception delay time of the control message related to the MBMS subchannel that exceeds a predetermined reference delay time is continuously detected by a predetermined first reference number, the electronic device 101 may determine that a condition for switching to the unicast scheme is satisfied in operation 929. For example, the state in which the condition for switching to the unicast scheme may indicate a state in which the multicast scheme cannot be continuously used because it is determined that the electronic device 101 is located at the edge (or in the weak electric field area) of the service area supporting the MBMS function.

According to various embodiments, when it is determined that the condition for switching to the unicast scheme is satisfied in operation 929, the electronic device 101 may transmit a message related to switching to the unicast scheme to the MCPTT server 900 in operation 931. For example, the message related to the switching to the unicast scheme is a listening status report message including information of “not-listening” and may be transmitted to the MCPTT server 900 in the form of an SIP message.

According to various embodiments, the MCPTT server 900 may transmit data (for example, media packets) to the electronic device 101 through the unicast scheme, based on reception of the message related to the switching to the unicast scheme in operation 933. According to an embodiment, the electronic device 101 may receive data from the MCPTT server 900 through the unicast scheme within the service area supporting the MBMS function.

According to various embodiments, when it is determined that the electronic device 101 escapes the service area supporting the MBMS function in operation 935, communication of the unicast scheme with the MCPTT server 900 may be maintained in operation 937. According to an embodiment, when system information block (SIB) 13 is not received, the electronic device 101 may determine that the electronic device 101 escapes the service area supporting the MBMS function.

According to various embodiments, the electronic device 101 and the MCPTT server 900 may establish an MCPTT group call with the MCPTT server 900 between a time point (for example, operation 911) at which the electronic device 101 accesses the MCPTT server 900 and a time point (for example, operation 917) at which it is determined that the MCPTT server 900 uses the multicast scheme for electronic devices belonging to the specific group within the service area. According to an embodiment, when the electronic device 101 accesses the MCPTT server 900, the MCPTT group call with the MCPTT server 900 may be established before location information (for example, a location report message) is transmitted to the MCPTT server 900.

According to various embodiments, the electronic device 101 may determine whether the condition for switching to the unicast scheme is satisfied based on the number of reception of the control message related to the MBMS subchannel for a predetermined first time. According to an embodiment, when the number of reception of the control message related to the MBMS subchannel for the predetermined first time is equal to or smaller than a predetermined second reference number, the electronic device 101 may determine that the condition for switching to the unicast scheme is satisfied. For example, the predetermined first time may include a reference time configured to identify the number of receptions of the control message related to the MBMS subchannel in order to determine whether the multicast scheme is used.

According to various embodiments, when timeout related to a floor request is generated, the electronic device 101 may determine that the condition for switching to the unicast scheme is satisfied. For example, the timeout related to the floor request may be generated when the electronic device 101 does not acquire a floor for a predetermined second time from a time point at which a floor request message is transmitted to secure the floor. For example, the predetermined second time may include a predetermined reference time to determine whether the timeout related to the floor request is generated.

According to various embodiments, the electronic device 101 may determine whether the condition for switching to the unicast scheme is satisfied based on a loss rate of data (or media packets) received from the MCPTT server 900 through the multicast scheme. According to an embodiment, when the low rate of the data (or media packets) received from the MCPTT server 900 for a predetermined third time exceeds a predetermined reference loss rate, the electronic device 101 may determine that the condition for switching to the unicast scheme is satisfied. For example, the predetermined third time may include a reference time for detecting the loss rate of the data received from the MCPTT server 900.

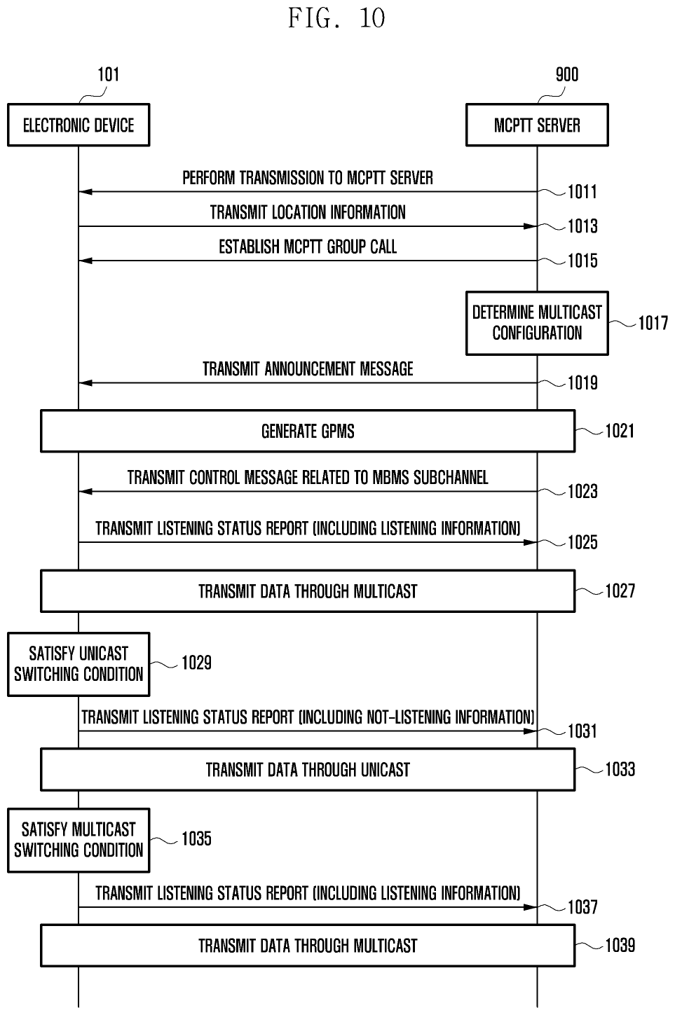

FIG. 10 illustrates an example for providing the MCPTT function by the electronic device according to an embodiment of the disclosure.

For example, the electronic device of FIG. 10 may be the electronic device 101 of FIG. 1, 2, 3, or 4. In the following description, operations 1011 to 1033 of FIG. 10 may correspond to operations 911 to 933 of FIG. 9.

Referring to FIG. 10, the electronic device 101 may access (or register in) the MCPTT server 900 in operation 1011.

According to various embodiments, when the electronic device 101 access (or register in) the MCPTT server 900 in order to provide the MCPTT function, the electronic device 101 may periodically transmit location information (for example, a location report message) to the MCPTT server 900, based on a predetermined first period in operation 1013.

According to various embodiments, the electronic device 101 may establish an MCPTT group call with the MCPTT server 900, based on generation of an event related to the start of the group call in operation 1015.

According to various embodiments, when the number of electronic devices belonging to a specific group within a service area (for example, the first service area 200 of FIG. 2 or 3) supporting the MBMS function exceeds a predetermined reference number, the MCPTT server 900 may determine that the multicast scheme is used for the electronic devices belonging to the specific group within the service area in operation 1017.

According to various embodiments, the MCPTT server 900 may transmit an announcement message including information related to generation of the GPMS to the electronic devices 101 belonging to the specific group within the service area, based on determination that the multicast scheme is used in operation 1019. For example, the announcement message may include information related to generation of the GPMS and a TMGI.

According to various embodiments, the electronic device 101 may generate the GPMS with the MCPTT server 900, based on information related to the MBMS function received from the MCPTT server 900 in operation 1021.

According to various embodiments, the MCPTT server 900 may periodically transmit the control message related to the MBMS subchannel through the GPMS, based on a predetermined second period in operation 1023.

According to various embodiments, when receiving the control message related to the MBMS subchannel from the MCPTT server 900 through the GPMS in operation 1023, the electronic device 101 may transmit a message related to switching to the multicast scheme to the MCPTT server 900 in operation 1025. For example, the message related to the switching to the multicast scheme is a listening status report message including information of “listening” and may be transmitted to the MCPTT server 900 in the form of an SIP message.

According to various embodiments, the MCPTT server 900 may transmit data (for example, media packets) to the electronic device 101 belonging to the specific group located in the service area supporting the MBMS function through the multicast scheme, based on reception of the message related to switching to the multicast scheme in operation 1027. For example, data of the multicast scheme may be transmitted through a media channel related to the multicast scheme.

According to various embodiments, when receiving data from the MCPTT server 900 through the multicast scheme, the electronic device 101 may determine whether the condition for switching to the unicast scheme is satisfied. According to an embodiment, when the reception delay time of the control message related to the MBMS subchannel that exceeds a predetermined reference delay time is continuously detected by a predetermined first reference number, the electronic device 101 may determine that the condition for switching to the unicast scheme is satisfied in operation 1029.

According to various embodiments, when it is determined that the condition for switching to the unicast scheme is satisfied in operation 1029, the electronic device 101 may transmit a message related to switching to the unicast scheme to the MCPTT server 900 in operation 1031. For example, the message related to the switching to the unicast scheme is a listening status report message including information of “not-listening” and may be transmitted to the MCPTT server 900 in the form of an SIP message.

According to various embodiments, the MCPTT server 900 may transmit data (for example, media packets) to the electronic device 101 through the unicast scheme, based on reception of the message related to the switching to the unicast scheme in operation 1033. According to an embodiment, the electronic device 101 may receive data from the MCPTT server 900 through the unicast scheme within the service area supporting the MBMS function.

According to various embodiments, when the electronic device 101 is located within the service area supporting the MBMS function, it may be determined whether the condition for switching to the multicast scheme is satisfied. According to various embodiments, when the GPMS with the MCPTT server 900 is maintained in the state in which the switching to the unicast scheme is performed, the electronic device 101 may periodically receive the control message related to the MBMS subchannel from the MCPTT server 900 through the GPMS, based on the predetermined second period. The electronic device 101 may determine whether the multicast scheme can be used based on reception status information of the control message related to the MBMS subchannel. According to an embodiment, when the reception delay time of the control message related to the MBMS subchannel that exceeds the predetermined reference delay time is not continuously detected by the predetermined first reference number, the electronic device 101 may determine that the condition for switching to the multicast scheme is satisfied in operation 1035. For example, the state in which the condition for switching to the multicast scheme may indicate a state in which the multicast scheme can be continuously used because it is determined that the electronic device 101 is in the strong electric field (or the weak electric field) area of the service area supporting the MBMS function.

According to various embodiments, when it is determined that the condition for switching to the multicast scheme is satisfied in operation 1035, the electronic device 101 may transmit the message related to switching to the multicast scheme to the MCPTT server 900 in operation 1037. For example, the message related to the switching to the multicast scheme is a listening status report message including information of “listening” and may be transmitted to the MCPTT server 900 in the form of an SIP message.

According to various embodiments, the MCPTT server 900 may transmit data (or media packets) to the electronic device 101 through the multicast scheme, based on reception of the message related to switching to the multicast scheme in operation 1039. According to an embodiment, the electronic device 101 may receive data from the MCPTT server 900 through a media channel (for example, the MBMS subchannel) related to the multicast scheme within the service area supporting the MBMS function.

According to various embodiments, the electronic device 101 and the MCPTT server 900 may establish an MCPTT group call with the MCPTT server 900 between a time point (for example, operation 1011) at which the electronic device 101 accesses the MCPTT server 900 and a time point (for example, operation 1017) at which it is determined that the MCPTT server 900 uses the multicast scheme for electronic devices belonging to the specific group within the service area. According to an embodiment, when the electronic device 101 accesses the MCPTT server 900, the MCPTT group call with the MCPTT server 900 may be established before location information (for example, a location report message) is transmitted to the MCPTT server 900.

According to various embodiments, the electronic device 101 may determine whether the condition for switching to the multicast scheme is satisfied based on the number of reception of the control message related to the MBMS subchannel for a predetermined first time. According to an embodiment, when the number of reception of the control message related to the MBMS subchannel for the predetermined first time exceeds a predetermined second reference number, the electronic device 101 may determine that the condition for switching to the multicast scheme is satisfied. For example, the predetermined first time may include a reference time configured to identify the number of receptions of the control message related to the MBMS subchannel in order to determine whether the multicast scheme is used.

According to various embodiments, the electronic device (for example, the electronic device 101 of FIG. 1, 2, 3, or 4) may establish a group call with the MCPTT server. According to an embodiment, the electronic device may include an operation of establishing at least one MBMS subchannel with the MCPTT server. According to an embodiment, the electronic device may include an operation of identifying a reception delay time of the control message related to the MBMS subchannel received through the GPMS in the state in which at least one MBMS subchannel is established. According to an embodiment, when the reception delay time of the control message related to the MBMS subchannel satisfies a predetermined first switching condition, the electronic device may include an operation of transmitting the message related to switching to the unicast scheme to the MCPTT server.

According to various embodiments, when the number of times the reception delay time of the control message related to the MBMS subchannel exceeds a predetermined reference delay time continuously exceeds a predetermined first reference number, the electronic device may include an operation of determining that the predetermined first switching condition is satisfied.

According to various embodiments, the electronic device may include an operation of transmitting a floor request signal through a floor control channel among at least one MBMS subchannel. According to various embodiments, when a response signal related to the floor request signal is not received for a predetermined first reference time, the electronic device may include an operation of transmitting the message related to switching to the unicast scheme to the MCPTT server.

According to various embodiments, the electronic device may identify a loss rate of data received through the media channel among the at least one MBMS subchannel for a predetermined second reference time. According to an embodiment, when the loss rate of the data exceeds a predetermined reference loss rate, the electronic device may include an operation of transmitting the message related to switching to the unicast scheme to the MCPTT server.

According to various embodiments, the electronic device may include an operation of identifying the reception delay time of the control message related to the MBMS subchannel received through the GPMS after the message related to switching to the unicast scheme is transmitted. According to an embodiment, when the reception delay time of the control message related to the MBMS subchannel satisfies a predetermined second switching condition, the electronic device may include an operation of transmitting the message related to switching to the multicast scheme to the MCPTT server.

According to various embodiments, when the number of times the reception delay time of the control message related to the MBMS subchannel exceeds a predetermined reference delay time does not continuously exceed a predetermined first reference number, the electronic device may determine that the predetermined second switching condition is satisfied.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a communication circuitry;
memory storing one or more computer programs; and
one or more processors operatively connected to the communication circuit and the memory,
wherein the one or more computer programs include computer-executable instructions that, when eecuted by the one or more processors individually or collectively, cause the electronic device to:
establish, via the communication circuitry, a group call with a mission critical push to talk (MCPTT) server,
establish, via the communication circuitry, at least one multimedia broadcast and multicast service (MBMS) subchannel with the MCPTT server,
identify a reception delay time of a control message related to an MBMS subchannel received through a general purpose MBMS subchannel (GPMS) in a state where the at least one MBMS subchannel is established, and
transmit, via the communication circuitry, a message related to switching to a unicast scheme to the MCPTT server when the reception delay time of the control message related to the MBMS subchannel satisfies a predetermined first switching condition.

2. The electronic device of claim 1, wherein the one ore more computer programs further include computer-executable instructions that, when executed by the one or more processors individually or collectively, cause the electronic device to determine that the predetermined first switching condition is satisfied in case that a number of times the reception delay time of the control message related to the MBMS subchannel exceeds a predetermined reference delay time continuously exceeds a predetermined first reference number.

3. The electronic device of claim 1,
wherein the MBMS subchannel comprises a floor control channel and a media channel related to multicast, and
wherein the one ore more computer programs further include computer-executable instructions that, when executed by the one or more processors individually or collectively, cause the electronic device to receive data from the MCPTT server through the media channel.

4. The electronic device of claim 3, wherein the one ore more computer programs further include computer-executable instructions that, when executed by the one or more processors individually or collectively, cause the electronic device to:
transmit a floor request signal through the floor control channel, and
transmit, via the communication circuitry, the message related to switching to the unicast scheme to the MCPTT server in case that a response signal related to the floor request signal is not received for a predetermined first reference time.

5. The electronic device of claim 3, wherein the one ore more computer programs further include computer-executable instructions that, when executed by the one or more processors individually or collectively, cause the electronic device to:
identify a loss rate of data received through the media channel for a predetermined second reference time, and
transmit, via the communication circuitry, the message related to switching to the unicast scheme to the MCPTT server in case that the loss rate of the data exceeds a predetermined reference loss rate.

6. The electronic device of claim 1, wherein the message related to switching to the unicast scheme comprises a listening status report related to not-listening.

7. The electronic device of claim 1, wherein the one ore more computer programs further include computer-executable instructions that, when executed by the one or more processors individually or collectively, cause the electronic device to:
identify the reception delay time of the control message related to the MBMS subchannel received through the GPMS after the message related to switching to the unicast scheme is transmitted, and
transmit the message related to switching to a multicast scheme to the MCPTT server through the communication circuitry in case that the reception delay time of the control message related to the MBMS subchannel satisfies a predetermined second switching condition.

8. The electronic device of claim 7, wherein the one ore more computer programs further include computer-executable instructions that, when executed by the one or more processors individually or collectively, cause the electronic device to determine that the predetermined second switching condition is satisfied in case that a number of times the reception delay time of the control message related to the MBMS subchannel exceeds a predetermined reference delay time does not continuously exceed a predetermined first reference number.

9. The electronic device of claim 7, wherein the message related to switching to the multicast scheme comprises a listening status report related to listening.

10. A method performed by an electronic device, the method comprising:
establishing a group call with a mission critical push to talk (MCPTT) server;
establishing at least one multimedia broadcast and multicast service (MBMS) subchannel with the MCPTT server;
identifying a reception delay time of a control message related to an MBMS subchannel received through a general purpose MBMS subchannel (GPMS) in a state where the at least one MBMS subchannel is established; and
transmitting a message related to switching to a unicast scheme to the MCPTT server when the reception delay time of the control message related to the MBMS subchannel satisfies a predetermined first switching condition.

11. The method of claim 10, further comprising:
in case that a number of times the reception delay time of the control message related to the MBMS subchannel exceeds a predetermined reference delay time continuously exceeds a predetermined first reference number, determining that the predetermined first switching condition is satisfied.

12. The method of claim 10, further comprising:
transmitting a floor request signal through a floor control channel among the at least one MBMS subchannel; and
transmitting the message related to switching to the unicast scheme to the MCPTT server in case that a response signal related to the floor request signal is not received for a predetermined first reference time.

13. The method of claim 10, further comprising:
identifying a loss rate of data received through a media channel among the at least one MBMS subchannel for a predetermined second reference time; and
transmitting the message related to switching to the unicast scheme to the MCPTT server in case that the loss rate of the data exceeds a predetermined reference loss rate.

14. The method of claim 10, further comprising:
identifying the reception delay time of the control message related to the MBMS subchannel received through the GPMS after the message related to switching to the unicast scheme is transmitted; and
transmitting the message related to switching to a multicast scheme to the MCPTT server in case that the reception delay time of the control message related to the MBMS subchannel satisfies a predetermined second switching condition.

15. The method of claim 14, further comprising:
determining that the predetermined second switching condition is satisfied in case that a number of times the reception delay time of the control message related to the MBMS subchannel exceeds a predetermined reference delay time does not continuously exceed a predetermined first reference number.

16. The method of claim 14, wherein the message related to switching to the multicast scheme comprises a listening status report related to listening.

17. The method of claim 10, wherein the message related to switching to the unicast scheme comprises a listening status report related to not-listening.

18. One or more non-transitory computer-readable storage media storing one or more computer programs including computer-executable insturctions that, when executed by one or more processors of an electronic device individualy or collectively, cause the electronic device to perform operations, the operations comprising: establishing a group call with a mission critical push to talk (MCPTT) server;
establishing at least one multimedia broadcast and multicast service (MBMS) subchannel with the MCPTT server;
identifying a reception delay time of a control message related to an MBMS subchannel received through a general purpose MBMS subchannel (GPMS) in a state where the at least one MBMS subchannel is established; and
transmitting a message related to switching to a unicast scheme to the MCPTT server when the reception delay time of the control message related to the MBMS subchannel satisfies a predetermined first switching condition.

19. The one or more non-transitory computer-readable storage media of claim 18, the operations further comprising:
transmitting a floor request signal through a floor control channel among the at least one MBMS subchannel; and
transmitting the message related to switching to the unicast scheme to the MCPTT server in case that a response signal related to the floor request signal is not received for a predetermined first reference time.

20. The one or more non-transitory computer-readable storage media of claim 18, the operations further comprising:
identifying a loss rate of data received through a media channel among the at least one MBMS subchannel for a predetermined second reference time; and
transmitting the message related to switching to the unicast scheme to the MCPTT server in case that the loss rate of the data exceeds a predetermined reference loss rate.
